(19) United States
(12) Patent Application Publication
(10) Pub. No.: US 2024/0066909 A1
(43) Pub. Date: Feb. 29, 2024

(54) PRE-LAMINATE FOR A DATAPAGE OF A SECURITY DOCUMENT AND METHOD OF FORMING THE SAME

(71) Applicant: LINXENS HOLDING, Mantes-La-Jolie (FR)

(72) Inventors: Somchard PHANNAM, Phra Nakorn Si Ayutthaya (TH); Arporn SUNGKHAPUN, Phra Nakorn Si Ayutthaya (TH); Khietisak KHAIPHO, Phra Nakorn Si Ayutthaya (TH); Maik NYSAR, Phra Nakorn Si Ayutthaya (TH)

(21) Appl. No.: 18/388,048

(22) Filed: Nov. 8, 2023

Related U.S. Application Data
(62) Division of application No. 17/312,830, filed on Jun. 10, 2021.

(51) Int. Cl. B42D 25/351; B32B 7/023; B32B 27/08; B32B 37/18; B42D 25/455

(52) U.S. Cl. CPC B42D 25/351; B32B 7/023; B32B 27/08; B32B 37/182; B42D 25/455; B42D 25/24

(57) ABSTRACT

A pre-laminate usable for forming a datapage of a security document, includes layers of different optical appearance, such as a clear window-type portion, which may be obtained on the basis of a substantially even or flat surface. Since the desired optical appearances of different areas of the pre-laminate are established in an early manufacturing stage, any process steps to be applied in a later manufacturing stage upon forming, for instance, an optical window, in a datapage, may be omitted, thereby contributing to reduced overall manufacturing costs and enhanced tamper resistance of the resulting datapage.

### CROSS-REFERENCES TO RELATED APPLICATIONS

This application is a divisional of U.S. patent application Ser. No. 17/312,830, entitled “A Pre-laminate for a Datapage of a Security Document and Method of Forming the Same,” filed on Jun. 10, 2021, which claims priority from PCT Application Serial No. PCT/IB2018/001568, entitled “A Pre-laminate for a Datapage of a Security Document and Method of Forming the Same,” filed on Dec. 17, 2018, the contents of which are hereby incorporated herein in their entirety by this reference.

### TECHNICAL FIELD

The present invention relates to security documents and the manufacturing thereof.

### BACKGROUND ART

Due to recent developments in society and industry, data processing and data handling requires the obeyance of increasingly restrictive regulations so as to reduce the possibility of tampering with sensitive data. In many applications, sensitive data or information has to be stored in a permanent and tamper resistant manner, in particular, when data or information in non-electronic form has to be stored, possibly in combination with electronically stored data, in certain carriers. For example, credit cards, respective cards for health insurance, passports and the like, represent respective “carriers” having stored therein a significant amount of non-electronic information, for instance, in the form of one or more images, symbols, text and the like. Typically, this information, possibly in combination with electronically stored data, such as RFID labels and the like, is provided on the basis of a respective carrier, hereinafter referred to as “security document,” which may have to provide for resistance of the stored information with respect to environmental influences, while, nevertheless, allowing frequent and long term use of a respective security document. For example, a passport may have to be typically used for a time period of several years and may, thus, depending on the habits of the passport owner, require a more or less frequent opening and closing, storing in sometimes harsh environments and the like, Similarly, any type of cards to be used in financial transactions and the like, may have to withstand mechanical stress upon interaction with respective card readers and the like, while also providing for high robustness and reliability during a daily use of any such security documents.

Moreover, in addition to mechanical robustness, the information included in a corresponding security document, such as a datapage of a passport and the like, has to provide for high tamper resistance so as to make difficult any intentional manipulation of the information stored in the respective datapage of the security document, while, preferably, upon attempting to manipulate the datapage, any such attempt should become recognizable in a visible or any other appropriate manner.

Since the various requirements imposed on a security document, or at least a respective datapage carrying the very sensitive data of the security document, are frequently mutually contradictive, as, for instance, frequent use of a passport requires highly flexible materials, which typically offer reduced durability and the like, great efforts have been or are currently being made in order to provide appropriate materials and manufacturing techniques for fabricating datapages of security documents with high robustness against many types of influences and high durability, while also providing a high level of security with respect to the tampering of sensitive data. To this end, plastic materials, in particular, polycarbonate, have been identified as viable candidates for fabricating datapages of security documents.

Typically, a datapage is formed as a stack of individual plastic layers, such as polycarbonate layers or sheets, which are stacked and cut into desired dimensions, thereby providing the possibility of inserting respective sensitive data carriers, such as an image and the like, and/or using one of the layers itself as a carrier of sensitive information. After having introduced at least a part of the sensitive data into the layer stack, the respective pre-laminate of the datapage may be heat treated so as to laminate the individual layers, thereby initiating a respective reaction between the individual surface areas, finally resulting in a more or less continuous piece of material, which may substantially not be separated in a later stage without inducing significant damage and, thus, leaving behind recognizable traces of any sort of tampering attempt. In addition to the high tamper resistance of a laminated datapage formed of appropriate plastic material, a high degree of resistance against many environmental influences, such as mechanical impact, chemical substances and the like, is also achieved.

Despite the many advantages of datapages formed of plastic materials, such as polycarbonate, it turns out that optical appearance, surface texture and the like, may frequently require a post-lamination procedure to obtain desired results, for instance, for providing an optically transparent window in an otherwise opaque plastic material and the like. A corresponding post-processing on the basis of the substantially completed datapage, may, however, require additional time and may possibly result in reduced robustness and/or tamper resistance of the final datapage having the desired optical appearance.

In view of the situation described above, it is an object of the present invention to provide means for designing specific characteristics, such as optical appearance, of a datapage for a security document, while avoiding or at least reducing the effects of one or more of the problems identified above.

### DISCLOSURE OF INVENTION

Basically, the present invention is based on the concept that, in particular, the optical appearance of a datapage of a security document may be adjusted in accordance with requirements in an early manufacturing stage, i.e., prior to laminating individual sheets or layers of a base material, such as a plastic material, for instance, in the form of polycarbonate and the like, thereby providing uniform material characteristics and superior tamper resistance, while potentially reducing overall manufacturing costs compared to a post-lamination procedure for adjusting optical appearance of datapages.

According to one aspect of the present invention, the problem identified above is specifically solved by a pre-laminate for a datapage of a security document. The pre-laminate includes a central layer having a bottom surface and a top surface. Moreover, the pre-laminate includes a top layer attached to the top surface, wherein the top layer has a first portion and a second portion with the first portion having a first optical appearance and the second portion having a second optical appearance differing from the first optical appearance. Additionally, the pre-laminate includes a bottom layer attached to the bottom surface and having a first portion and a second portion, wherein the first portion has a third optical appearance. Furthermore, the central layer, the top layer and the bottom layer form a stacked structure with the first portion of the top layer and the first portion of the bottom layer being aligned with respect to a stacking direction of the stacked structure.

Consequently, different optical appearances are implemented in the pre-laminate in an aligned manner prior to actually converting the pre-laminate into the datapage by laminating the individual layers. In this manner, the desired first, second and third optical appearances may be implemented without affecting the material characteristics of the final datapage, while still leaving the high degree of flexibility in dimensioning, positioning and aligning the various portions of the first optical appearance in accordance with overall requirements. Consequently, any post-lamination processes for establishing a desired photo-optical appearance of a datapage may be omitted, thereby also contributing to reduced overall manufacturing cost and increased durability and reliability of the resulting datapage.

In a preferred embodiment at least a portion of the central layer aligned with the second portions of the top and bottom layers has the first or third optical appearance. In one embodiment the first and third optical appearances are substantially identical. For example, if the optical appearance is basically defined by transmittance of visible light, a more or less transparent portion may be provided in the preform depending on the magnitude of transmittance.

In a further embodiment, the first portion of the top layer is laterally surrounded by the second portion of the top layer. That is, the first portion having the first optical appearance is provided as a “layer internal” portion, thereby enabling a high degree of flexibility in patterning the resulting optical appearance of the top layer. For example, in one illustrative embodiment, the first portion having the first optical appearance may have a relatively high transmittance in a desired wavelength range, for instance, in the visible wavelength range, thereby forming a “window” in the second portion having the second optical appearance.

In another illustrative embodiment, the first portion of the bottom layer is laterally surrounded by the second portion of the bottom layer. As discussed above with respect to the top layer, the total optical appearance of the bottom layer may also be patterned so as to provide for a window-type appearance, wherein the respective first portions of the top layer and the bottom layer are aligned to each other with respect to the stacking direction.

In one embodiment, the second portion of the bottom layer has the second optical appearance, thereby providing for a high degree of consistency in the total optical appearance of the pre-laminate and, thus, of the finally obtained datapage when viewing the same from the front and back side thereof.

As already discussed above, in one embodiment, a visible light transmittance associated with the first optical appearance is higher than a visible light transmittance associated with the second optical appearance. Therefore, the first portions of the top layer and the bottom layer may act as windows for providing visibility, at least to a certain degree, along the stacking direction into the central area of the pre-laminate.

In one embodiment, the first portion of the top layer and the first portion of the bottom layer have a same lateral size and shape. In this manner, in particular, consistency between the front side and back side of the pre-laminate and, thus, of the finally obtained datapage, may not only be accomplished by similar optical appearance, but also on the basis of identical lateral dimensions and lateral shape of the portions that are used for patterning the optical appearance. It should be appreciated, however, that in other embodiments, the lateral size and/or the lateral shape of the first portions may differ from each other, if a specific optical effect is to be implemented.

Moreover, in this context, it should be appreciated that the term “optical appearance” is to be understood as the optical response of a material to a specific radiation within a predetermined range of wavelengths of the incident radiation. More specifically, optical appearance is to be understood in the context of the present application as the optical response of a material or layer that is irradiated with radiation, including wavelengths ranging from approximately 200 nm to 1000 nm. The optical response to this incident radiation may then be specified by at least one parameter, such as the partial or entire transmittance of a wavelength range of the incident radiation, polarization of the back-radiating portion under consideration, frequency of at least a part of the radiation and the like. In this respect, the optical appearance of a first portion is considered as basically identical to the optical appearance of a second portion, when respective values of a parameter used for describing the optical appearance, such as transmittance and/or polarization and/or frequency, and the like, are substantially identical, except for any measurement errors, when measured under identical conditions.

In a further illustrative embodiment, the first and the second portions of the top layer are formed of a same first base material. It is well known that many plastic materials may be provided with different optical characteristics, while having substantially the same basic chemical configuration. For example, plastic materials that are frequently used for datapages of security documents may be provided with different colors by incorporating respective colorants in order to obtain a desired effect. In particular, polycarbonate may be provided with different optical appearance and may, thus, represent an appropriate base material for the first and second portions of the top layer.

Similarly, the first and second portions of the bottom layer may be formed of a same second base material, such as any appropriate plastic material, in particular, polycarbonate and the like. Thus, when forming the first and second portions of the top and bottom layers from respective same base materials, in particular, a further processing may result in highly uniform material characteristics of the top and bottom layer, respectively.

In particular, when the base materials of the top and bottom layer are selected as the same base material, superior conditions for processing these layers may be achieved, thereby resulting in highly uniform material characteristics of the finally obtained datapage. In one illustrative embodiment, a central layer is formed of the same base material as the top and bottom layers, thereby obtaining a pre-laminate of uniform material characteristics even prior to the lamination process. Furthermore, the various layers may be prepared individually on the basis of the same base material, thereby also contributing to reduced overall reduced manufacturing costs.

In one preferred embodiment, the first and second portions of the top layer are flush in the stacking direction and the first and second portions of the bottom layer are also flush in the stacking direction. In this manner, the pre-laminate of the datapage has no specific surface topography and, thus, provides for a substantially flat surface, which may translate into respective surface characteristics of the final datapage after the lamination process. Consequently, the flat surface of the pre-laminate at the top and bottom layers and the resulting flat surface characteristics after incorporating any sensitive data and laminating the stacked layers may provide for superior overall appearance and increased tamper resistance, while, nevertheless, providing for desired lateral “patterning” of the optical appearance of the final datapage. For example, in one illustrative embodiment, the first optical appearance may provide for a certain magnitude of optical transmittance and may provide for an optical window in the datapage, when the central layer is also provided in the form of an optically transmissive material. In this manner, respective data, such as an image and the like, may be efficiently viewed through the optical window, while, nevertheless, providing high tamper resistance and durability, since a substantially flat surface is provided in the final datapage on the basis of the pre-laminate, as discussed above.

According to another aspect of the present invention, the above-identified object is solved by a pre-laminate for a datapage of a security document. The pre-laminate includes a stacked structure including two or more layers attached to each other, wherein each of the two or more layers includes a respective transparent portion. Furthermore, the transparent portions of the two or more layers are aligned in a stacking direction of the stacked structure.

Consequently, an optically transparent portion may be provided at any lateral position, thereby enabling the viewing of sensitive information or data through the respective transparent portions, irrespective of the stacking of these layers.

In one illustrative embodiment, at least one of the two or more layers includes a non-transparent portion. Consequently, also in this case a respective structuring of the optical appearance of the pre-laminate may be accomplished by using different degrees of transparency in at least one of the layers, thereby providing the potential of hiding specific areas of the datapage, while providing optical access to specific sensitive information via the transparent portions.

In one illustrative embodiment, the at least one non-transparent portion and the respective one of the transparent portions are flush in the stacking direction. Therefore, a flat surface topography is obtained in the pre-laminate, which may also translate into a substantially flat surface configuration of the final datapage.

In a further illustrative embodiment, the stack structure includes a central layer having a bottom surface and a top surface, a top layer attached to the top surface and a bottom layer attached to the bottom surface, wherein the central layer is transparent. Consequently, a multilayer structure is obtained in the pre-laminate, wherein the transparency, i.e., the appropriate optical appearance, of the central layer provides for the potential of seeing through the pre-laminate, irrespective of the lateral position of the respective transparent portions of the top and bottom layers.

In an advantageous embodiment, the two or more layers of the stack structure are made from a same base material. Therefore, advantages with respect to reduced complexity of the overall manufacturing process, reduced manufacturing costs, superior overall material characteristics and the like, may be achieved.

According to a still further aspect of the present invention, the above-identified technical object is solved by a method of forming a pre-laminate of a datapage for a security document. The method includes the step of attaching a top layer to a top surface of a central layer, wherein the top layer includes a first cut-out portion. Furthermore, a bottom layer is attached to a bottom surface of the central layer, wherein the bottom layer includes a second cut-out portion, wherein the top layer, the bottom layer and the central layer form a stacked structure. The method further includes aligning the first and second cut-out portions in a stacking direction of the stacked structure. Finally, the method includes filling the first and second cut-out portions with a fill material having a different optical appearance compared to the remainder of the top and bottom layers.

The method of the present invention will, therefore, result in a pre-laminate as previously specified, thereby contributing to superior process conditions and, thus, reduced manufacturing costs, in particular, since the different optical appearances may be accomplished on the basis of a fill material in an early manufacturing stage, i.e., prior to actually laminating the various layers of the stack structure.

In a further illustrative embodiment, the step of filling the first and second cut-out portions includes: inserting a first portion of the fill material into the first cut-out portion of the top layer so as to be flush with the remainder of the top layer, and inserting a second portion of the fill material into the second cut-out portion of the bottom layer so as to be flush with the remainder of the bottom layer. Consequently, the pre-laminate may be provided with a flat surface configuration after having implemented a specific portion with a desired optical appearance by means of the fill material, thereby reducing any structural deviations in the surface structure, even after laminating the stacked structure for obtaining the final datapage.

### BRIEF DESCRIPTION OF THE DRAWINGS

FIG. 1 schematically illustrates a cross-sectional view of a pre-laminate in accordance with the principles disclosed herein; and

FIG. 2 schematically illustrates a top view of a datapage that is formed by using the pre-laminate of FIG. 1.

### BEST MODE(S) FOR CARRYING OUT THE INVENTION

As discussed above, the present invention is based on the concept that areas of different optical appearance may be provided in a datapage, which, according to the technique disclosed herein, is accomplished in an early manufacturing stage upon forming a desired stacked structure, which has the desired optical appearance prior to forming a continuous piece of material from the pre-laminate.

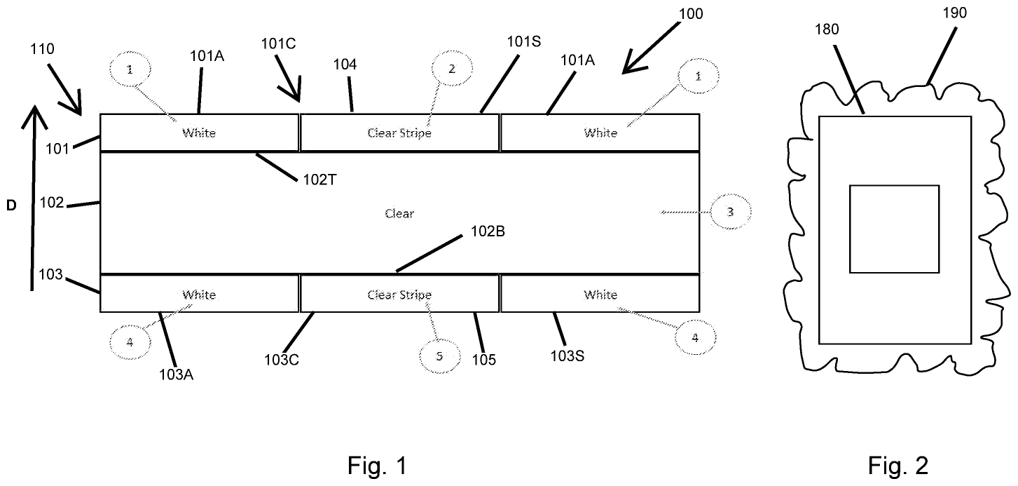

With reference to FIGS. 1 and 2 further illustrative embodiments will now be described in more detail.

FIG. 1 schematically illustrates a cross-sectional view of a pre-laminate 100, which is intended to become a datapage, such as a datapage 180 of a security document 190 as shown in FIG. 2. For example, the datapage 180 may have an appropriate configuration so as to represent a part of the security document 190 in order to hold sensitive data or information, such as sensitive data of a passport, a credit card and the like. To this end the pre-laminate 100 is appropriately sized and configured for receiving any type of sensitive information that has to be carried and protected by the pre-laminate 100 when performing a lamination process so as to obtain the datapage 180 having substantially uniform material characteristics, thereby providing for high tamper-resistance, as already discussed above.

The pre-laminate 100 is typically provided in the form of a layer stack or stacked structure 110 that includes two or more individual material sheets or layers which may allow insertion of the type of desired information or data into the stacked structure 110. The data or information may then be “encapsulated” in the stacked structure 110 after performing a respective lamination process, as discussed above.

In illustrative embodiments, the stacked structure 110 comprises at least two individual material layers, such as layers 101 and 103, the optical characteristics of which may have to be adapted with respect to the overall requirements and may at least impart a desired “patterning” of the optical appearance to the pre-laminate 100. In the embodiment shown, the layer 101, which may also be indicated as a top layer, may comprise a first portion 101A that has a specific optical appearance. As discussed above, optical appearance may be defined as optical response of a specific material to an incident radiation, wherein the term “optical” in the context of the present application is to include a wavelength range of 200 nm to 1000 nm. For example, the portion 101A of the top layer 101 is formed from a specific base material, such as polycarbonate or other equivalent plastic materials, wherein certain colorants and the like may result in a specific color or optical appearance.

In one embodiment, the portion 101A is substantially opaque with respect to light of the visible range, thereby hiding any underlying areas of the stacked structure 110. It should be appreciated that a certain degree of light transmittance may be implemented by appropriately preparing the respective base material, thereby also providing the potential of adjusting a desired color. For example, the color “white” is frequently used in security documents for providing substantially non-transmissive portions of a datapage. It should be appreciated, however, that any desired color may be implemented, as long as the respective colorants to be inserted into the base material are compatible with the overall material requirements of the final datapage 180.

Furthermore, the optical appearance may be basically determined, in one embodiment, by the degree of light transmittance, without requiring a substantially total blocking of any penetrating light rays. In other cases, as also discussed above, the optical appearance is determined by any appropriate parameter, such as absorbance, reflectivity and the like, wherein respective values of one or more parameters that define the optical appearance of a specific material or portion may be determined on the basis of same test conditions or environmental conditions so that different parameter values obtained during the specific conditions represent an explicit indication of a specific optical appearance.

Consequently, the portion 101A, having a specific optical appearance that is defined by one or more appropriately selected parameters, such as transmittance and the like, imparts certain optical characteristics to the layer 101, which additionally comprises a further portion 104 of appropriate lateral dimensions, i.e., the dimensions in the horizontal direction and the direction perpendicular to the drawing plane of FIG. 1. The optical appearance of the portion 104 is different from the optical appearance of the portion 101A, thereby resulting in a specific “patterning” of the total optical appearance of layer 101, depending on the difference in optical appearances and the size, shape and position of the portion 104 with respect to the portion 101A. In one embodiment, the portion 104 is positioned within the layer 101 so as to be laterally surrounded by the portion 101A, thereby forming a window-type or island-type part of the layer 101. In one illustrative embodiment, the optical appearance of the portion 104 corresponds to increased transmittance, at least in the visible wavelength range, compared to the portion 101A, so that the portion 104 may provide a view into the stacked structure 110.

In other illustrative embodiments, the optical appearances of the portions 101A, 104 may differ due to a different optical response within a specific wavelength range, for instance, in the UV range, if considered appropriate. The portion 104 is, in one embodiment, formed so as to have substantially the same layer thickness as the portion 101A, wherein layer thickness is to be understood as the dimension of the portion 104 or 101A along a stacking direction D. In this case, the portion 104 is substantially flush with the portion 101A along the stacking direction D, thereby obtaining a substantially flat surface 101S of the layer 101.

It should be appreciated that although the portions 104 and 101A have different optical appearances, for example, different optical light transmittance for radiation in the visible wavelength range, in one illustrative embodiment, these portions are formed from the same base material, such as polycarbonate. In one illustrative embodiment, the portion 104 may be made of substantially clear polycarbonate material, while the portion 101A is formed from a substantially opaque polycarbonate material, such as a white polycarbonate and the like.

Similarly, the layer 103, also referred to as “bottom layer,” has a portion 103A of desired lateral size and shape and with an optical appearance that complies with the overall requirements of the pre-laminate 100. Furthermore, a portion 105 is formed in the layer 103 so as to have a desired lateral size and shape and to provide an optical appearance that differs from the optical appearance of the portion 103A. Basically, the same criteria apply for the portion 105 in combination with the portion 103A as discussed above in the context of the layer 101, i.e., the portions 104 and 101A.

In the embodiment illustrated in FIG. 1, the lateral size and shape of the portions 104, 105 are identical and also the portions 104 and 105 are aligned along the stacking direction D.

In one illustrative embodiment, the optical appearance of the portion 105 is substantially the same as the optical appearance of the portion 104, thereby substantially imparting the same optical appearance to the pre-laminate 100 when viewed from a front side or a back side thereof. In other illustrative embodiments, the optical appearances of the portions 104 and 105 may differ from each other and may also differ from the optical appearances of the portions 101A and 103A, thereby achieving superior flexibility in adjusting the overall optical appearance of the pre-laminate 100. For example, the portions 104, 105 may differ from each other in terms of transmittance, color, response to non-visible radiation and the like. In other cases, the portions 104, 105 have a relatively high transmittance, for instance, as a substantially clear material, thereby providing see-through capabilities to the stacked structure 110. Nevertheless, even for substantially identical response to radiation in the optical wavelength range, the optical appearances of the portions 104, 105 may differ in other illustrative embodiments with respect to optical response in a non-visible wavelength range, depending on the overall requirements with respect to optical response of the pre-laminate 100.

In one illustrative embodiment, as, for instance, illustrated in FIG. 1, the pre-laminate 100 comprises at least one further layer 102 positioned, with respect to the stacking direction D, between the top layer 101 and the bottom layer 103. The layer 102 may be adapted with respect to layer thickness, lateral size and shape so as to comply with the overall requirements of the pre-laminate 100. In one illustrative embodiment, the layer 102, also referred to as a central layer, has an optical appearance that complements the optical appearances of the portions 104, 105 in order to obtain a desired total optical appearance or optical effect. In one preferred embodiment, at least a central portion (not shown) of the layer 102 has similar optical appearance, at least with respect to transmittance in the optical wavelength range, thereby providing the possibility of a see-through portion in the pre-laminate 100. A corresponding configuration may be highly advantageous in the context of security documents that require image data to be identified, while still providing for a high degree of tamper resistance, as already discussed above. For example, frequently an image of an owner of a security document or any other relevant symbols or tokens have to be identified by human eye and/or image recognition systems, while other areas of the finally obtained datapage 180 may have to respond very differently to an optical examination of the security document.

In one illustrative embodiment, the layer 102 as a whole is formed of a material having the optical appearance as required adjacent to the portions 104, 105. For example, if a high degree of transmittance is necessary at the portions 104, 105, the layer 102 may be provided in the form of a substantially clear plastic material, such as clear polycarbonate. It should be appreciated, however, that the layer 102 may basically comply with transmittance requirements, but may, however, have a different color so as to allow a further overall adaptation of optical response of the pre-laminate 100, as considered appropriate.

When forming the pre-laminate 100, depending on the overall complexity of the stacked structure 110, one layer of the structure 110 may be provided with any appropriate optical characteristics, as discussed above. For example, the layer 101 may be attached to a top surface 102T of the central layer 102 by any appropriate means, such as adhesion enhancing agents, mechanical attachments means (not shown) and the like. In one illustrative embodiment, the layer 101 is provided with a cut-out portion 101C that corresponds in position, size and shape to the portion 104. Consequently, after having attached the layer 101 to the surface 102T, an appropriate fill material, also denoted by reference numeral 104, is appropriately prepared and inserted into the cut-out portion 101C, thereby providing the desired material characteristics and optical appearance for the portion 104, as previously discussed. Furthermore, by using the fill material or portion 104, the thickness may be adapted so as to obtain the substantially flat surface 101S, as also discussed above. The fill material or portion 104 may be attached to the layers 101 and 102 by any appropriate means, such as mechanical attachment, adhesion agents and the like.

Thereafter, the layer 103 may be attached to a bottom surface 102B of the layer 102, which may be accomplished by, for instance, flipping the previously assembled layers 101 and 102 and using the same working equipment for aligning the layer 103 with respect to the layer 102, wherein, also in this case, a cut-out portion 103C may be present in the layer 103. The respective cut-out portion may be prepared at any appropriate stage of the overall manufacturing process. Also, the lateral position, size and shape of the portion 105 may be defined by the cut-out portion 103C, which may then be filled with an appropriate fill material, also denoted by the same reference numeral 105, in order to implement the required characteristics, in particular, the optical appearance of the layer 103. Moreover, the fill material or portion 105 may be attached by any appropriate means, such as mechanical attachment, adhesion agent and the like. Consequently, by appropriately selecting the position, size and shape of the cut-out portions 101C and 103C, the lateral “patterning” of the optical appearances of the pre-laminate 100, when viewed from a front side, i.e., from the layer 101, and when viewed from the back side, i.e., from the layer 103, may be appropriately adjusted, while the total optical response may also be selected on the basis of the respective fill materials or portions 104, 105. For instance, by using a substantially clear material for the portions 104, 105, and a clear material at least for the central part of the layer 102, a see-through window is obtained in the pre-laminate 100.

It should be noted that the stacked structure 110 may be formed on the basis of two layers, such as the layers 101, 103, without providing the central layer 102, or more than three layers may be provided in the stacked structure 110, if this is required by respective demands imposed on the pre-laminate 100. In this case, the optical appearance of respective parts adjacent to the portions 104, 105 are appropriately selected in order to obtain the total optical response of the portions 104, 105.

It should be further appreciated that processing the stacked structure 110 so as to have the appropriate lateral dimensions may be accomplished by preparing the layers 101, 102, 103 with appropriate dimensions in advance, or, in other cases, the stacked structure 110 may be cut into the desired dimensions after having attached at least some of the layers 101, 102, 103.

In this stage, the pre-laminate 100 may receive any further treatment so as to store thereon or therein sensitive data, security features and the like, as is necessary for the security document 190. Thereafter, the stacked structure 110, including any additional security features and sensitive data may be heat treated so as to form a laminated material, which, in some illustrative embodiments, may have substantially flat outer surface areas due to the surfaces 101S and 103S of the pre-laminate 100. Consequently, the resulting datapage 180 may exhibit superior surface characteristics and, therefore, increased tamper resistance, while still providing for a desired optical appearance, such as a window-type appearance, due to the portions 104, 105 and, if provided, any further materials of appropriate optical appearance, such as the layer 102.

FIG. 2 illustrates the security document 190 in top view with the datapage 180 formed by using the pre-laminate 100, as discussed above. In the embodiment shown, the datapage 180 includes a window-type portion 184 having the optical appearance as determined by the pre-laminate 100, as explained above. For example, the portion 184 may represent a see-through portion with high transparency, when respective portions of the pre-laminate, such as the portions 104, 105 and possibly other portions of further layers, such as the layer 102, have been provided with a desired high degree of optical transmittance. On the other hand, a remaining portion 181A of the datapage may be opaque. It should be appreciated, however, that the portions 184 and 181A may have any desired optical appearances as long as the respective optical appearances of the portions 181A and 184 differ from each other. Similarly, the lateral shape, the size and position may be adjusted depending on the requirements of the security document under consideration.

What is claimed is:

1. A method of forming a pre-laminate of a datapage for a security document, the method comprising
attaching a top layer to a top surface of a central layer, said top layer comprising a first cut-out portion;
attaching a bottom layer to a bottom surface of said central layer, said bottom layer comprising a second cut-out portion, said top layer, said bottom layer and said central layer forming a stacked structure;
aligning said first and second cut-out portions in a stacking direction of said stacked structure; and
filling said first and second cut-out portions with a fill material having a different optical appearance compared to the remainder of said top and bottom layers.

2. The method of claim 1, wherein filling said first and second cut-out portions comprises inserting a first portion of said fill material into said cut-out portion of the top layer so as to be flush with the remainder of said top layer and inserting a second portion of said fill material into said cut-out portion of the bottom layer so as to be flush with the remainder of said bottom layer.

3. The method of claim 1, wherein said central layer has the same optical appearance as the fill material of said top layer.

4. The method of claim 1, wherein the fill material of said top layer has the same optical appearance as the fill material of said bottom layer.

5. The method of claim 1, wherein the remainder material of said top layer has the same optical appearance as the remainder material of said bottom layer.

6. The method of claim 1, wherein the fill material of said top layer has a first optical appearance and the remainder material of said top layer has a second optical appearance, and a visible light transmittance associated with said first optical appearance is higher than a visible light transmittance associated with said second optical appearance.

7. The method of claim 1, wherein said cutout portion of said top layer and said cutout portion of said bottom layer have a same lateral size and shape.

8. The method of claim 1, wherein said fill material of said top layer is formed of the same first base material as said top layer.

9. The method of claim 1, wherein said fill material of said bottom layer and said bottom layer are formed of a same second base material.

10. The method of claim 1, wherein said fill material of said top layer, said top layer, said fill material of said bottom layer, and said bottom layer are formed of a same base material.

11. The method of claim 10, wherein said central layer is formed of said same base material.

12. The method of claim 1, wherein each of said top layer, central layer or bottom layer comprises a transparent portion, and said transparent portions are aligned in said stacking direction of said stacked structure.

13. The method of claim 12, wherein at least one of said top layer, central layer or bottom layer comprises a non-transparent portion.

14. The method of claim 13, wherein said at least one non-transparent portion laterally surrounds a respective one of said transparent portions.

15. The method of claim 12, wherein at least one of said top layer, central layer or bottom layer is a transparent layer.
